(19) United States
(12) Patent Application Publication
(10) Pub. No.: US 2016/0349813 A1
(43) Pub. Date: Dec. 1, 2016

(54) Process and Hardware for Proactively Protecting Computers and Mobile Devices Against Bad Weather

(71) Applicant: William G. DiSessa, Holly, MI (US)

(72) Inventor: William G. DiSessa, Holly, MI (US)

(21) Appl. No.: 14/726,193

(22) Filed: May 29, 2015

(51) Int. Cl. G06F 1/26

(52) U.S. Cl. CPC G06F 1/26

(57) ABSTRACT

A software application (FIG. 1) whose cloud component (FIG. 1.202) obtains bad-weather alerts (FIG. 2.200) from one or more online weather service (FIG. 3.400) and delivers them to the computer-based components of affected users. The computer-based program, wirelessly communicating (FIG. 9.900) with a hardware chassis component (FIG. 4.400), turns off the computer and then, using a relay switch (FIG. 11.300) in the chassis circuitry, virtually unplugs the machine. This offers proactive, remote protection to unattended, plugged-in computers, networks, tablets, smartphones and other devices against power surges and outages caused by bad weather. Good protection: a shut-down computer; best protection: an unplugged computer. The software is multi-platform, available for Windows and Mac computers, networks, laptops and tablets, as well as iPhones and smartphones.

### CROSS-REFERENCE TO RELATED APPLICATIONS

This application claims the benefits of provisional patents Ser. No. 62/006,152, filed 2014 May 31, and Ser. No. 62/092,218, filed 2014 Dec. 15 by the present inventor.

### BACKGROUND

### Prior Art

The following is a tabulation of some prior art that presently appears relevant:

U.S. Patents

| Patent Number | Kind Code | Issue Date | Patentee |
|---|---|---|---|
| U.S. Pat. No. | B2 | 2010 Sep. 14 | Kazuo Miwa |
| 7,797,084 | | | |
| U.S. Pat. No. | A | 1997, Apr. 15 | Bernd D. Winkelmann; |
| 5,621,602 | | | original assignee: |
| | | | International Resistive |
| | | | Company, Inc. |
| U.S. Pat. No. | B1 | 2004, Mar. 23 | James O. Fagoli; |
| 6,710,790 | | | original assignee: |
| | | | Symantec Corporation |

U.S. Patent Application Publications

| | | Publication | |
|---|---|---|---|
| Patent Number | Kind Code | Date | Applicant |
| US20140191573 | A1 | Jul. 10, 2014 | Andrew Yuen Chin |
| | | | Chen, Amy Decem |
| | | | Cheng, Tsz Kai TAM; |
| | | | original assignee: |
| | | | Kool Koncepts Limited |
| US20130046852 | A1 | Feb. 21, 2013 | Anurekh Saxena, Tejasvi |
| | | | Aswathanarayana; |
| | | | original assignee: |
| | | | Antecea, Inc. |

Surge protectors, such as U.S. Pat. No. 5,621,602 (1997), protect computers and mobile devices from power surges and outages. But their scope is limited in that they are reactive devices, attempting to block power surges or outages occurring in milliseconds. In this way, surge protectors serve as a “live or die” last line of defense against a damaged or destroyed computers or similar devices.

Surge protectors are reliable, but not infallible. They can fail to protect electronic devices during power outages or surges, especially when electrical power to a building flashes on and off two or more times in swift succession. Such events, often caused by lightning, can destroy a computer or similar device. This especially is so when a computer or similar device is plugged into a wall outlet, but can even occur when a surge protector is used.

Even with surge protectors in place, computers and mobile devices are at-risk during certain bad-weather conditions, such as lightning strikes, regardless of whether they are on or off. But they are most vulnerable when unattended, plugged in and left on. For instance, lightning can strike a building, run along an electrical line or current, bypass or defeat a surge protector, and destroy a computer motherboard.

Energy management systems, such as U.S. Pat. No. 7,797,084 (2010) and U.S. patent application Ser. 20140191573 (2014), enable proactive control of certain electronic devices in a home or office. According to its abstract, U.S. patent application Ser. 20140191573 (2014) can be configured to automatically switch peripheral appliances on or off by detecting master appliances being in standby state, even though these appliances are located far away from each other in a premise, or even in other premises.

The system, as described in U.S. patent application Ser. 20140191573 (2014), is also capable of detecting whether the included appliances are plugged or unplugged to facilitate simple and efficient management of appliance power consumption for the sake of energy saving. This invention is concerned with energy management of appliances, however, and not with remote, proactive and automatic protection of unattended computers, tablets and mobile devices from bad weather-induced power surges and outages.

Software such as pcAnywhere, or U.S. Pat. No. 6,710,790 (2004), allows one user with a computer to remotely access another computer. But this system is not designed or intended to provide proactive, automatic and remote protection of an unattended computer or similar device from power surges or outages due to bad weather or other causes.

Specifically, software such as U.S. Pat. No. 6,710,790 (2004) is only minimally effective at protecting an unattended computer or mobile device. This is because the user may be unaware of bad weather near the unattended device or may not have immediate access to a computer to remotely access the unattended device. Additionally, the software itself offers no direct protection to hardware.

Similarly, a system, such as U.S. patent application Ser. 20130046852 (2013), uses a mobile device and an installed application to enable one computer to access another remotely. However, this system is concerned with improving remote-access issues and with typical remote-access tasks, such as file and screen access. It also requires a user at the controls. It is not designed or intended to provide proactive, automatic and remote protection of an unattended computer or similar device from power surges or outages due to bad weather or other causes.

No known prior art exists that is directly germane to the embodiments in this application.

### SUMMARY

In accordance with one embodiment, a software application for Windows and Macs shuts down unattended computers and tablets remotely, and then wirelessly commands a hardware chassis with a circuit board and wireless chip to virtually unplug the device, when bad weather threatens the surrounding area, thereby proactively avoiding data loss, hardware damage or destruction.

### Advantages

Thus some embodiments provide proactive, automatic and remote protection for unattended computers and tablets; some embodiments provide such protection for unattended mobile devices; and some embodiments provide such protection for unattended computer networks and other wireless devices. These and other benefits of one or more aspects will become apparent from a consideration of the ensuing description and accompanying drawings.

### DRAWINGS—FIGURES

FIG. 1 is a process flow of the first embodiment.

FIG. 2 illustrates a typical online weather API¹, including codes identifying various weather events (e.g., severe thunderstorm warning), which the first embodiment uses as keys to shut down computers at risk of storm-related electrical damage.

FIG. 3 provides a perspective of the first-embodiment's hub-and-spoke design.

FIG. 4 is a front view of the first-embodiment's chassis.

FIG. 5 is a rear view of the first-embodiment's chassis.

FIG. 6 is a perspective view of the first-embodiment chassis.

FIG. 7 is an overview of the electrical schematics of first-embodiment chassis.

FIG. 8 is a detailed description of the electrical schematics of the first-embodiment chassis.

FIG. 9 is a continued detailed description of the electrical schematics of the first-embodiment chassis.

FIG. 10 is a continued detailed description of the electrical schematics of the first-embodiment chassis.

FIG. 11 is the process flow of the hardware chassis.

FIG. 12 is an additional embodiment.

FIG. 13 is an additional embodiment.

FIG. 14 is an additional embodiment.

FIG. 15 is an additional embodiment.

Drawings-Reference Numbers

| | |
|---|---|
| Reference Number | Description |

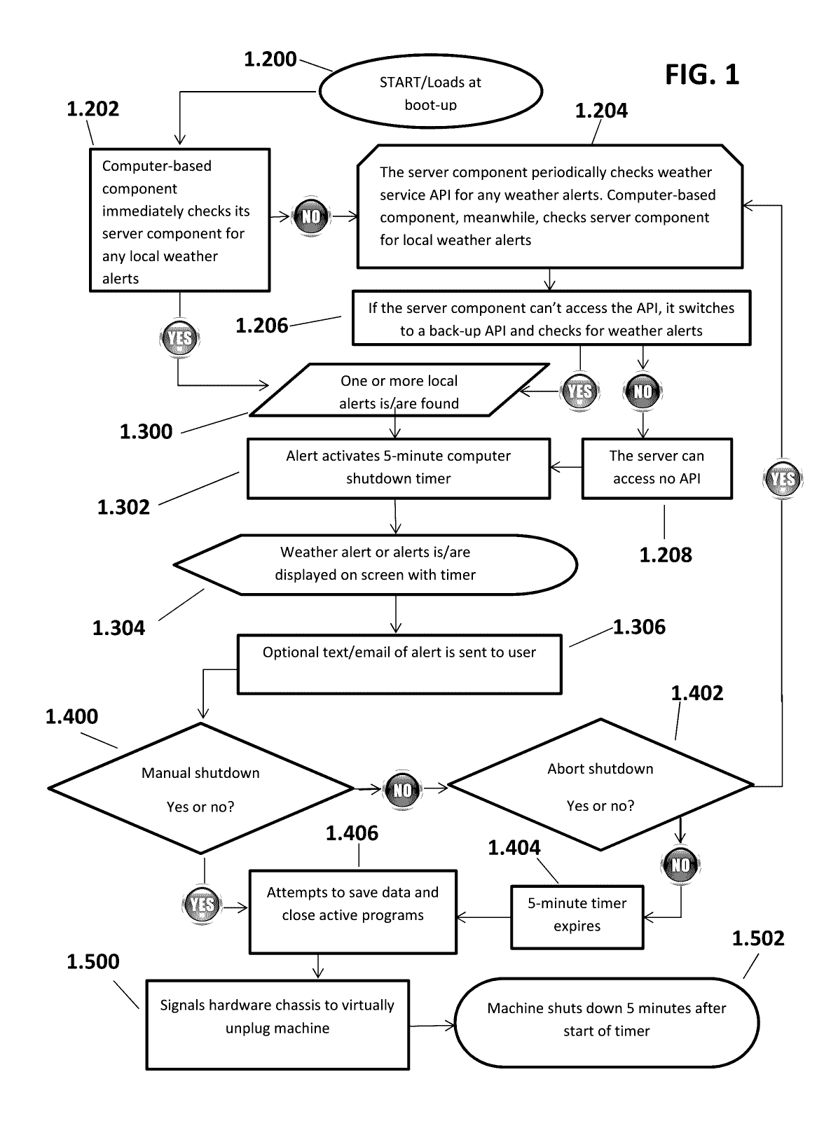

FIG. 1-Software Process Flow

| | |
|---|---|
| 1.200 | Software Application loads at computer boot- |
| | up |
| 1.202 | Computer-based component immediately |
| | checks its server component for any weather |
| | alerts for user's location |
| 1.204 | While program is in computer memory, its |
| | server component checks weather-service API |
| | server periodically (e.g., once an hour) for any |
| | weather alerts. Computer-based software |
| | component, meanwhile, checks its server hub |
| | component for local alerts at the same intervals |
| 1.206 | If server component cannot access an API |
| | during one of its checks, it switches to a back- |
| | up API |
| 1.208 | If no API is found, the shutdown timer in |
| | FIG. 1.302 is started |
| 1.300 | One or more local alerts is/are found |
| 1.302 | Alert activates 5-minute computer shutdown |
| | timer |
| 1.304 | Weather alert or alerts is/are displayed on |
| | screen with timer |
| 1.306 | Optional text/email of alert is sent to user |
| 1.400 | Manual shutdown - yes or no? |
| 1.402 | Abort shutdown - yes or no |
| 1.404 | 5-minute timer expires |
| 1.406 | Attempt to save data and close active programs |
| 1.500 | Signals hardware chassis to virtually unplug |
| | machine |
| 1.502 | Computer shuts down 5 minutes after start of |
| | timer |

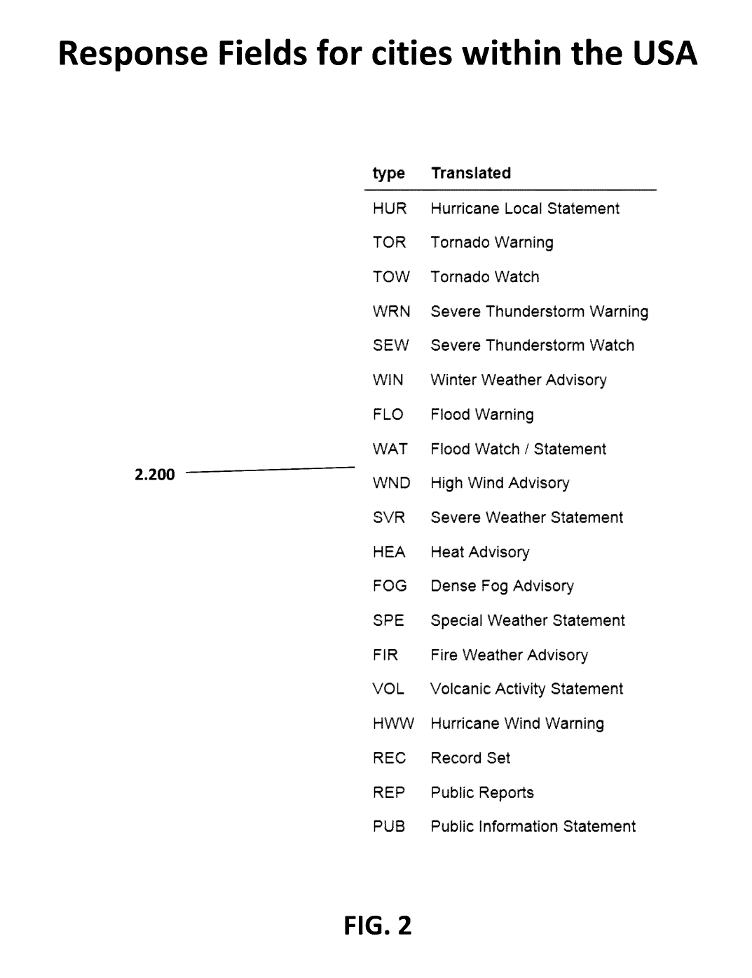

FIG. 2-Weather Codes of Sample Weather Service API

| | |
|---|---|
| 2.200 | Response Fields for cities within the USA |

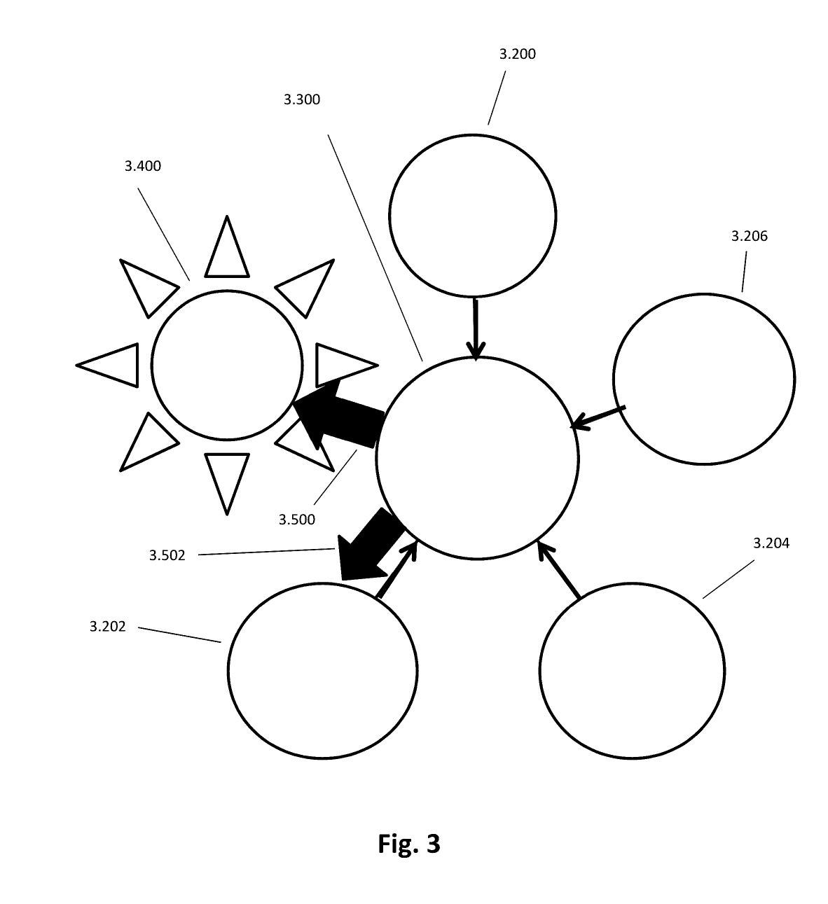

FIG. 3-Software Application Server Component Overview

| | |
|---|---|
| 3.200, 3.202, | Example Users A, B, C and D |
| 3204 and 3.206 | |
| 3.300 | Software application's server or hub |
| 3.400 | Weather service API/server |
| 3.500 | Software application server/hub periodically |
| | checks weather service for bad-weather alerts |
| 3.502 | The software application server/hub releases |
| | bad-weather alerts to users |

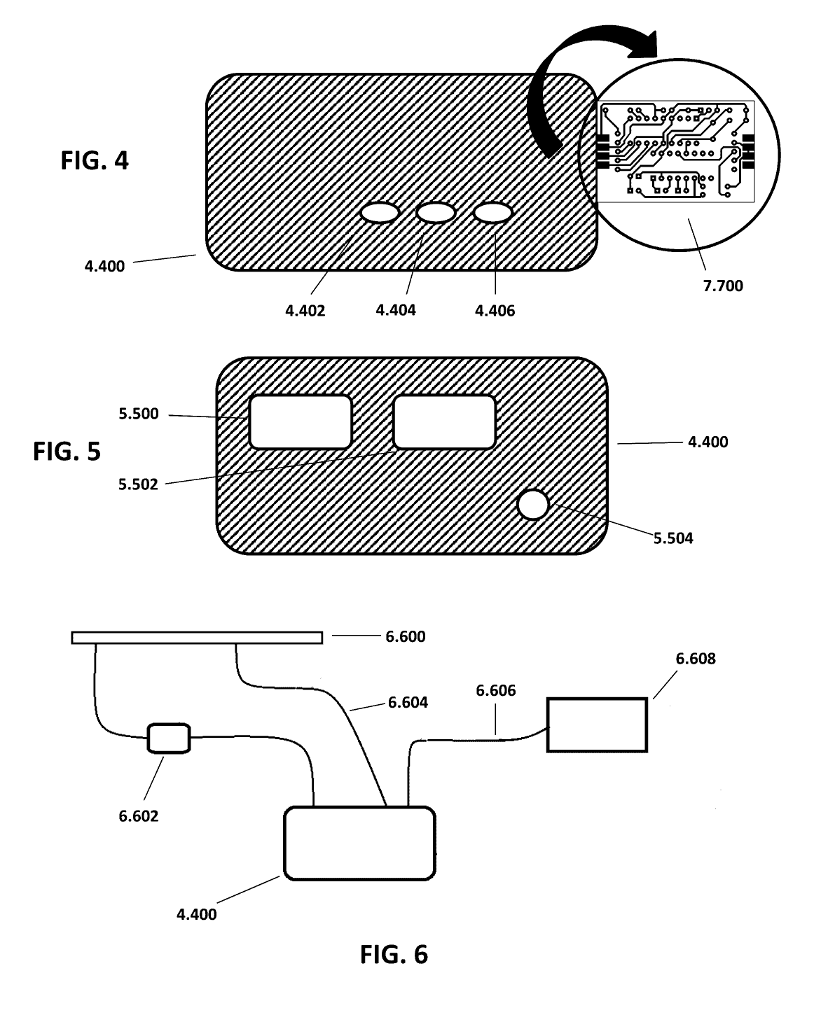

FIG. 4-Front View of the Chassis

| | |
|---|---|
| 4.400 | Chassis |
| 4.402 | LED power on/off status light |
| 4.404 | LED working status light |
| 4.406 | LED trouble status light |
| 7.700 | Circuit board |

FIG. 5-Rear View of the Chassis

| | |
|---|---|
| 4.400 | Chassis |
| 5.500 | AC output source |
| 5.502 | AC input source |
| 5.504 | DC input (+5 V) where an AC adapter plugs in |
| | to provide power to the circuit board |

FIG. 6-Perspective of the Chassis

| | |
|---|---|
| 4.400 | Chassis |
| 6.600 | Wall outlet or available surge suppressor |
| 6.602 | Adapter supplying +5 V to the chassis |
| 6.604 | AC power cord to the chassis |
| 6.606 | AC power cord that connects the chassis to the |
| | computer |
| 6.608 | Computer with Wi-Fi or Bluetooth |

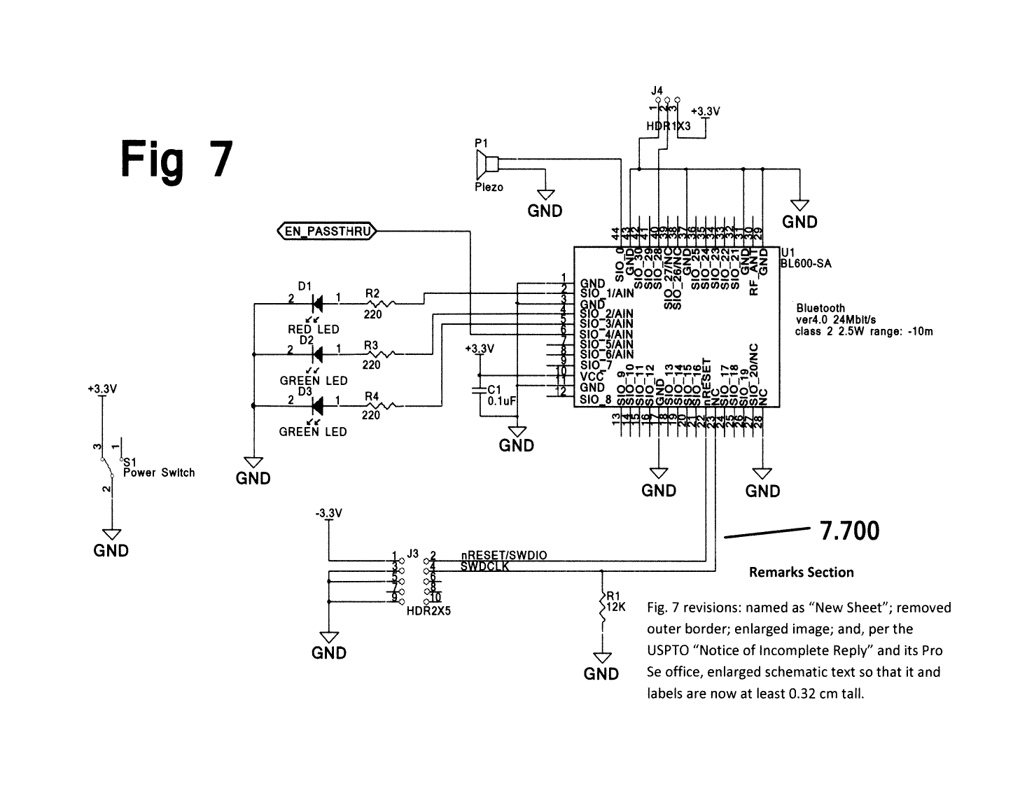

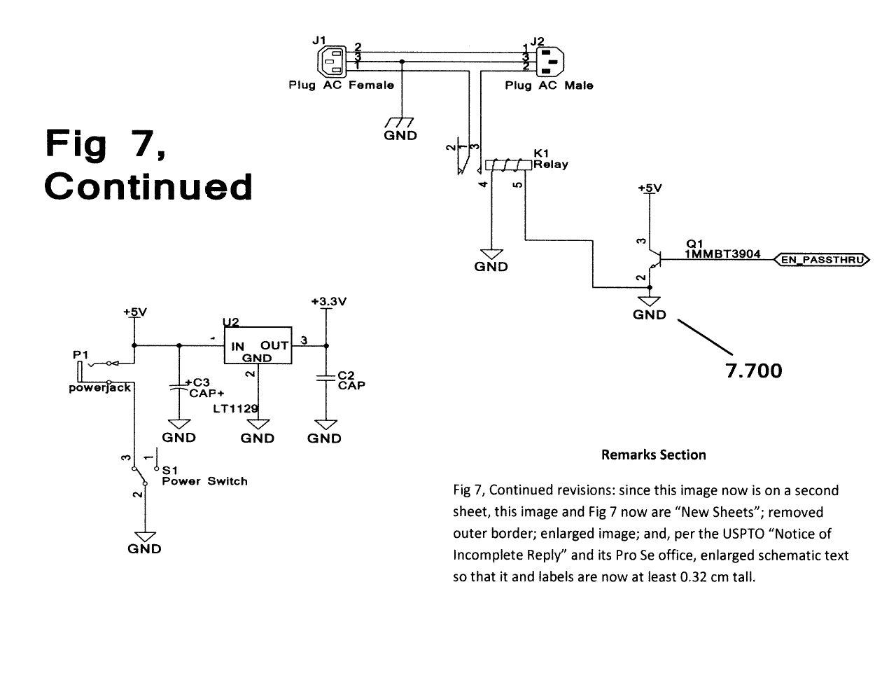

FIG. 7-Perspective of Chassis Circuit Board

| | |
|---|---|
| 7.700 | Holistic views of the entire circuit board |
| | housed in the chassis |

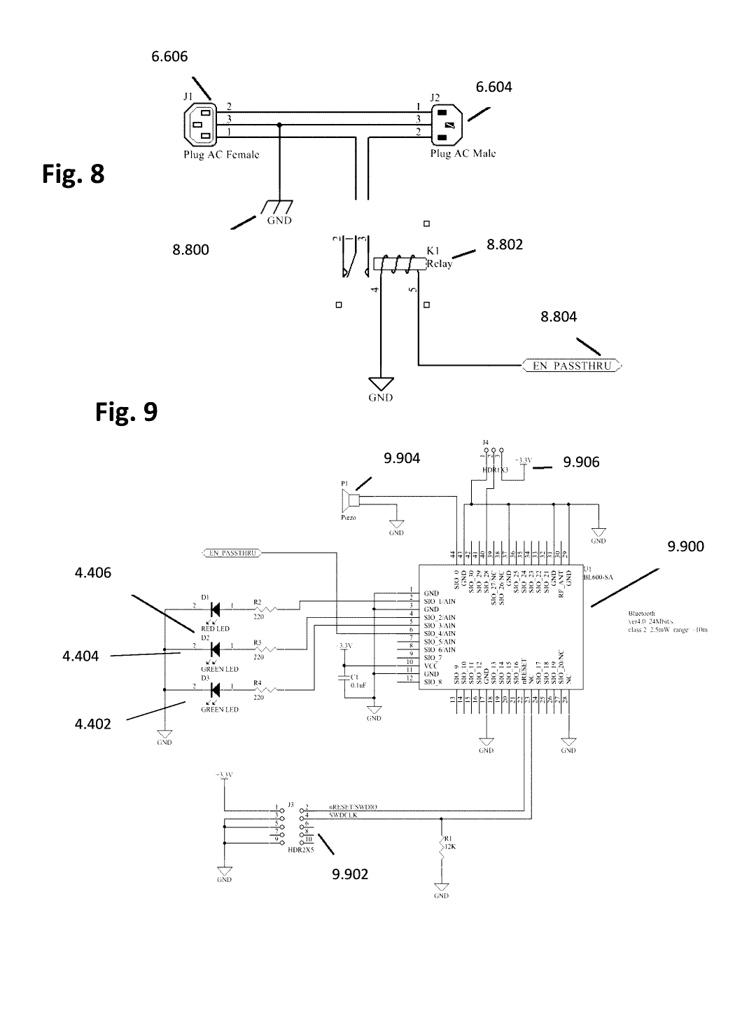

FIG. 8-Details of Chassis Electrical Schematics

| | |
|---|---|
| 6.604 | AC power cord to the chassis |
| 6.606 | AC power cord that connects the chassis to the |
| | computer |
| 8.800 | AC cord's standard earth-ground cable |
| | connecting to the chassis |
| 8.802 | Relay that controls the flow of power through |
| | the chassis and computer |
| 8.804 | Enablement of EN_PASSTHRU control signal |
| | that lets power pass from connector one to two |
| | of the chassis' two AC plugs |

FIG. 9-Details of Chassis Electrical Schematics, Continued

| | |
|---|---|
| 4.402 | LED power on/off status light |
| 4.404 | LED working status light |
| 4.406 | LED trouble status light |
| 9.900 | Wi-Fi and/or Bluetooth chip |
| 9.902 | Programming port that accesses the chip |
| 9.904 | Buzzer that sounds an audible alert warning of |
| | an imminent computer shutdown |
| 9.906 | Wi-Fi or Bluetooth configuration jumper; |
| | developer configuration settings used only for |
| | testing |

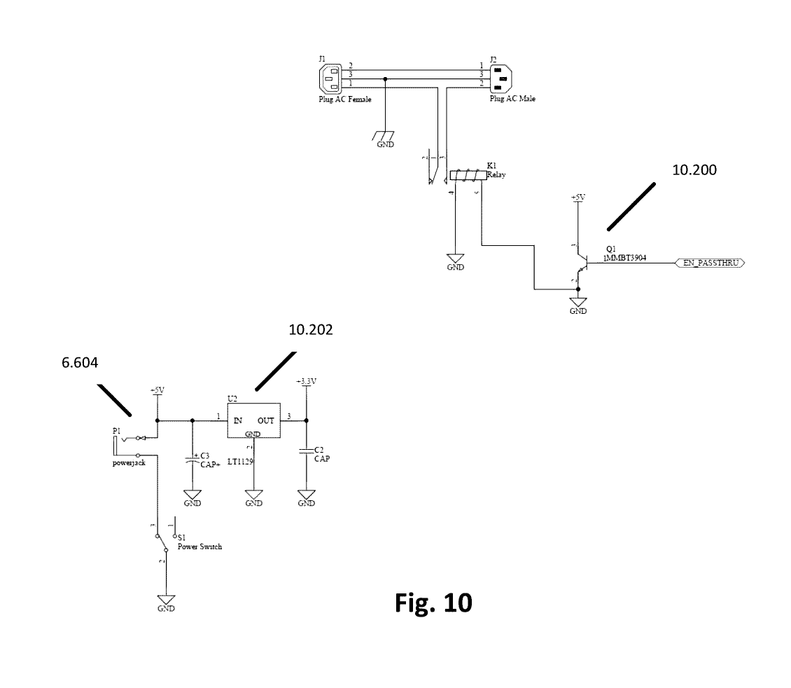

FIG. 10-Details of Chassis Electrical Schematics, Continued

| | |
|---|---|
| 10.200 | Transistor that enables the relay if a Bluetooth |
| | chip is used |
| 10.202 | Regulator chip that provides power to enable |
| | the relay and optional Bluetooth chip |
| 6.604 | AC power cord to the chassis |

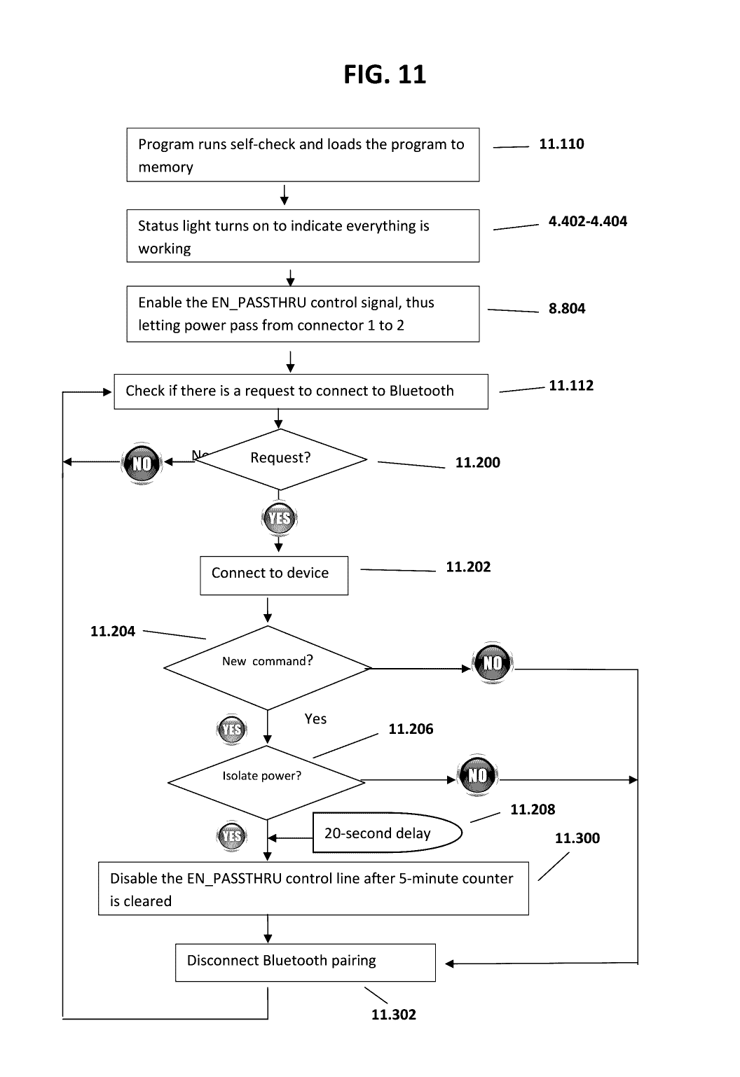

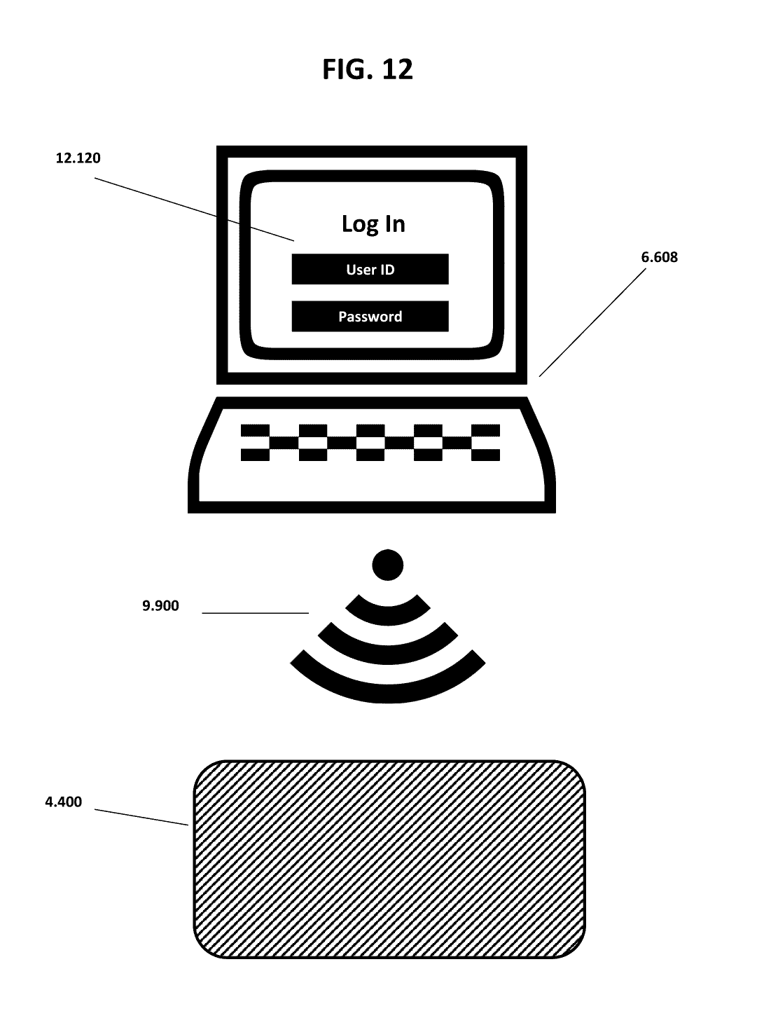

FIG. 11-Process Flow of Chassis

| | |
|---|---|
| 11.110 | Chip programming runs a self-check and loads |
| | program into wireless chip's memory |
| 4.402-4.406 | LED indicates system is functioning/system |
| | status |
| 8.804 | Enablement of EN_PASSTHRU control signal |
| | that lets power pass from connector one to two |
| | of the chassis' two AC plugs |
| 11.112 | Polls the software application for a wireless |
| | connection request or shutdown signal |
| 11.200 | If no signal is detected, the system waits for a |
| | connection request |
| 11.202 | If a signal is detected, the wireless chip |
| | connects to the computer |
| 11.204 | If no such wireless signal is received, the |
| | wireless pairing is disconnected |
| 11.206 | If the chip receives a wireless signal from the |
| | software application to virtually unplug the |
| | computer, it switches the relay open |
| 11.208 | The relay open switch occurs after a 20-second |
| | delay |
| 11.300 | EN-_PASSTHRU control line cuts the flow of |
| | voltage to 0 V, virtually unplugging the |
| | computer or tablet from its power source |
| 11.302 | The wireless pairing is disconnected |

FIG. 12-Additional Embodiment

| | |
|---|---|
| 4.400 | Chassis |
| 6.608 | Computer |
| 9.900 | Wireless connection |
| 12.120 | Web-based software application |

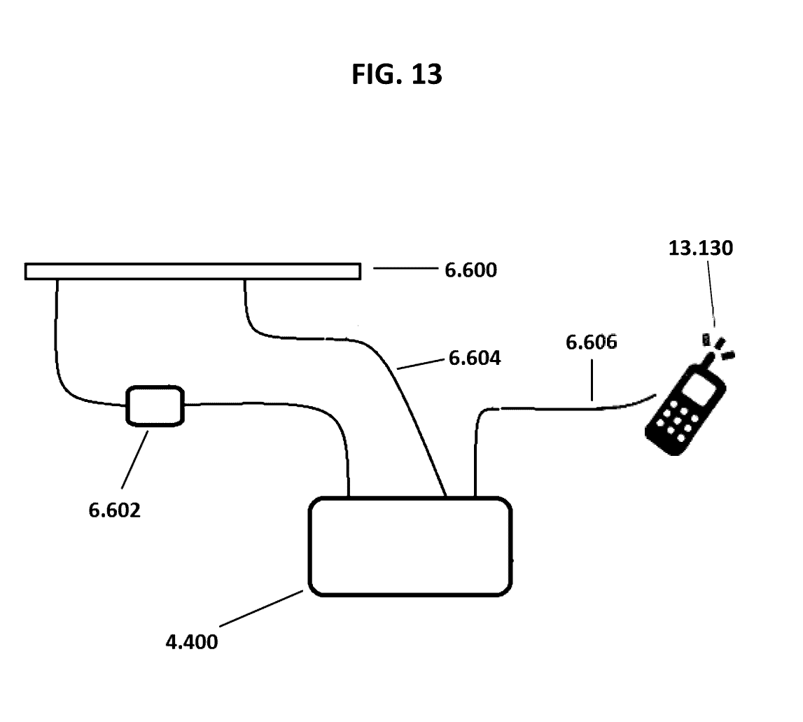

FIG. 13-Additional Embodiment

| | |
|---|---|
| 4.400 | Chassis |
| 6.600 | Wall outlet or available surge suppressor |
| 6.602 | Adapter supplying +5 V to the chassis |
| 6.604 | AC power cord to the chassis |
| 6.606 | AC power cord that connects the chassis to the |
| | computer |
| 13.130 | Mobile phone |

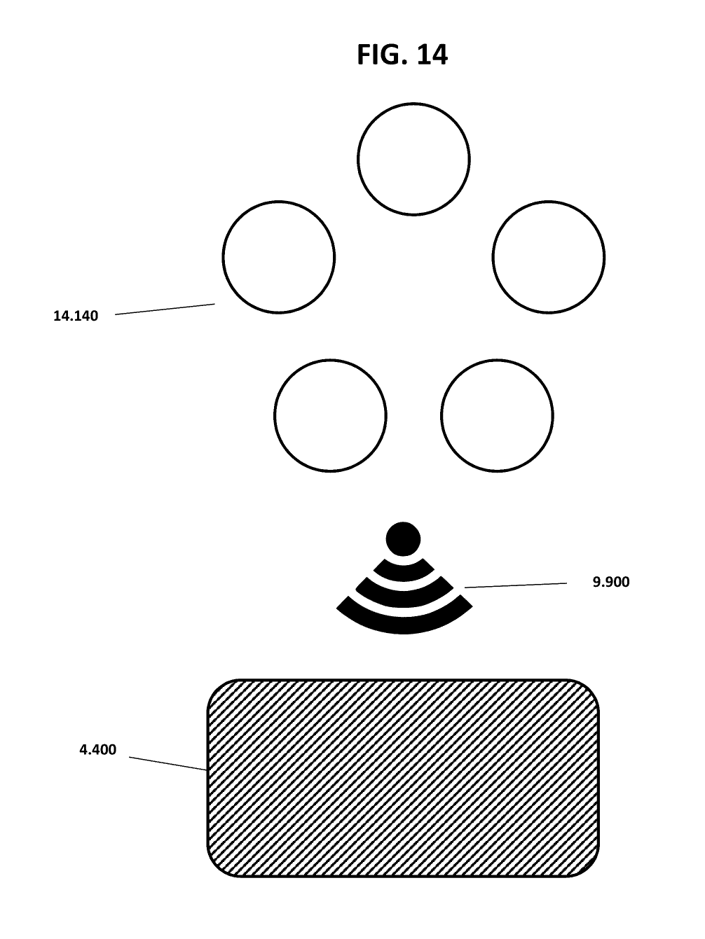

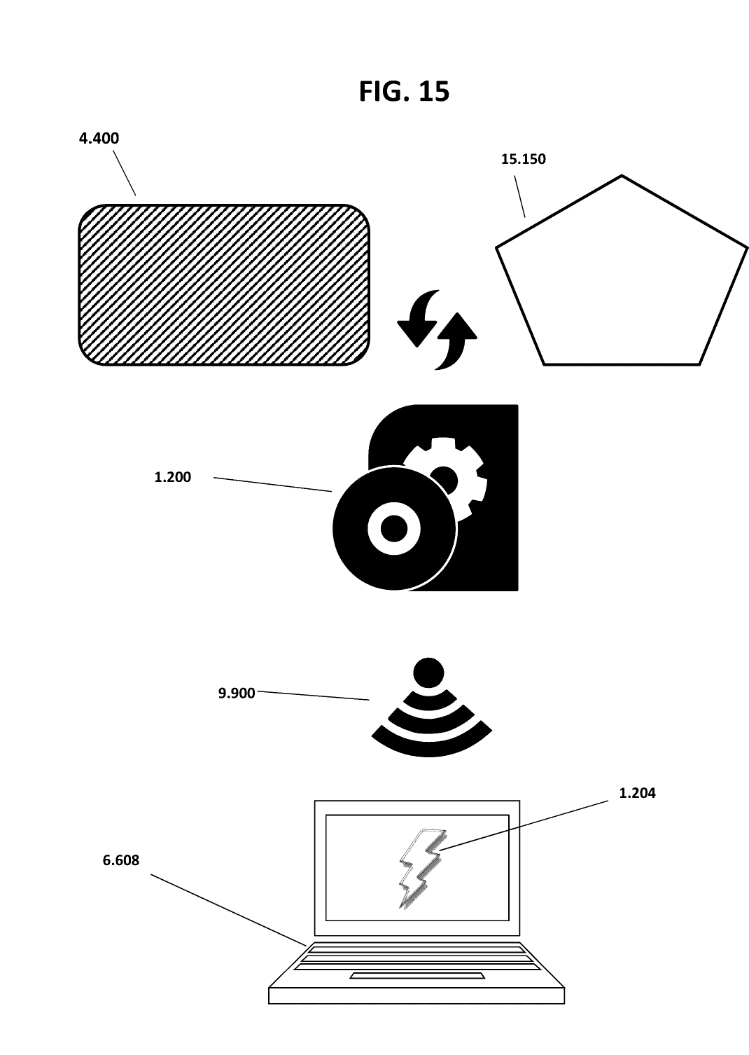

FIG. 14-Additional Embodiment

| | |
|---|---|
| 4.400 | Chassis |
| 9.900 | Wireless connection |
| 14.140 | Network of computers |

FIG. 15-Additional Embodiment

| | |
|---|---|
| 4.400 | Chassis |
| 6.608 | Computer |
| 9.900 | Wireless connection |
| 15.150 | Incorporating conventional surge suppressor |
| | into chassis |

### DETAILED DESCRIPTION—FIGS. 1-11—FIRST EMBODIMENT

FIG. 1 shows a process flow of one embodiment, a software desktop application for Windows and Mac computers, using a programming language compatible with both operating systems. One such example is Adobe Air.

FIG. 2 shows an example of weather alerts for a weather-service application program interface (API) that one embodiment of the software application uses to obtain real-time weather data. This example is presently available at: http://www.wunderground.com/weather/api/d/docs?d=data/alerts&MR=1

Some weather-service APIs provide national weather data, others provide global weather data. One embodiment of this software application may use one or more national and global weather services to ensure redundancy of data availability in case a primary weather service stops working temporarily or permanently.

FIG. 3 shows one embodiment consists of the software application for users and a cloud-based component application (FIG. 3.400) that accesses one or more weather-service APIs.

In accordance with FIG. 3, the software application uses a hub-and-spoke design to reduce the load on weather service API servers.

The software application contains a conventional desktop software Preferences menu, where users must enter their location, according to the one embodiment of the software. The location may be a street address or Global Positioning Satellite (GPS) coordinates, if compatible with the selected weather-service API.

One embodiment of the software application, via the Preferences menu, may allow users to choose a primary weather-service APIs and one or more back-ups, in case the default or selected service is temporarily down. They may also choose select a default language, such as English, French, Spanish, Chinese, Japanese or Arabic.

If the cloud-based component of the program cannot access a weather-service API, the computer-based program switches to a back-up API (FIG. 1.206). If no API is available (FIG. 1.208), the program starts the 5-minute shutdown timer in FIG. 1.302.

In another embodiment, there may be a default or primary weather-service API, along with one or more default back-ups, eliminating user selection of weather services.

The Preferences menu also may allow users to choose some optional weather events (FIG. 2.200) that trigger a shutdown of their machines (FIG. 1.502). For instance, since users A and B (FIGS. 3.200 and 3.202) live near a large body of water, they may want the program to check for maritime-related alerts, if available from the API in use. Similarly, users C and D (FIGS. 3.204 and 3.206) live along the Gulf Coast so they may opt for hurricane warnings, if available from the API in use.

FIGS. 4 and 5 are front and rear views of the hardware chassis (FIG. 4.400), in one embodiment. The chassis includes exterior status lights (FIGS. 4.402-4.406), AC input and output sources (FIGS. 5.500-5.502) and a DC input (FIG. 5.504) where an AC adapter plugs in to provide power to the chassis' circuit board.

FIG. 6 shows a perspective of the first embodiment of the chassis, made of plastic with an integral or modular case design. It contains a circuit board (FIG. 7); and wireless technology—either a Wi-Fi or Bluetooth chip (FIG. 9.902), or a combined chip.

FIGS. 8, 9 and 10 provide a detailed breakdown of the electrical schematics and components of the chassis. These will be discussed in more detail in the Operation section of this application.

FIG. 6 shows one conventional AC power cord connecting the chassis to a wall outlet or available surge suppressor, and a second conventional AC power cord connecting the Wi-Fi-equipped computer to the chassis.

In more detail, FIG. 10 shows the conventional AC power cord plugging (male) into a wall outlet or available surge protector (female receptacle), and connecting with the chassis. Per FIG. 10, a second conventional AC power cord of the computer plugs (male) into a female receptacle on the chassis.

In one embodiment, the software application and hardware chassis communicate wirelessly (FIG. 9.900) with the purpose of shutting down (FIG. 1.502) and then virtually unplugging (FIG. 11.300) an unattended computer shortly after a bad-weather alert (FIG. 1.300) is received. Moments before the hardware chassis virtually unplugs the computer, the software application shuts down the computer.

### OPERATION—FIGS. 1-11—FIRST EMBODIMENT

In the Preferences menu of the computer-based software application, the user may choose optional types of weather events (FIG. 2), to activate a shutdown. For instance, a user living near a lake or ocean may want the program to check for maritime-related alerts, if available in the API. Default or mandatory weather events include tornado watches and warnings, and severe thunderstorm warnings.

If the cloud-based component of the program cannot access a weather-service API, it switches to a back-up API (FIG. 1.206). If none is available (FIG. 1.208), the computer-based program activates the countdown timer (FIG. 1.302).

The first embodiment of the computer-based software application loads into the machine's memory at boot-up (FIG. 1.200). It immediately checks the cloud component, (FIG. 1.202), for any new weather alerts for the user's location. If it finds one or more alerts, it activates the 5-minute countdown timer in FIG. 1.302. If it finds no alerts, the program periodically (e.g., every 30 or 60 minutes) checks for local alerts while running in the background (FIG. 1.204).

Meanwhile, the software's cloud component (FIG. 3.300) periodically checks at similar intervals for bad-weather alerts (FIG. 3.500) from one or more weather-service API (FIG. 3.400).

The cloud component only delivers bad-weather alerts to affected machines (FIG. 3.502), based on locations configured by their users during set-up of the software application.

When the Wi-Fi-equipped computer (FIG. 6.608) is running normally and there are no local bad-weather alerts, one embodiment of the chassis (FIG. 4.400) allows power to flow from the wall outlet or available surge suppressor to the computer.

The chassis connects to a wall outlet or available surge suppressor (FIG. 6.600) via a conventional AC plug, which includes an earth-ground cable (FIG. 8.800), and electrical cord (FIG. 6.604). The computer's AC cord plugs (FIG. 6.606) into the chassis.

The chassis houses: an insulated circuit board (FIGS. 7-7.700), typically made of green fiberglass; on which a Wi-Fi or Bluetooth microchip (FIG. 9.900), or a combined chip, is mounted or etched; and a regulator chip (FIG. 10.202) that provides power to the system. It also houses: a programming port (FIG. 9.902), used to download programming to the wireless chip; and a configuration jumper with developer settings used only for testing purposes (FIG. 9.906). A DC adapter provides power to the chassis (FIG. 5.504).

FIGS. 4.402, 4.404 and 4.406 show the LED's power on/off; working; and trouble statuses, respectively.

FIG. 5.500 shows the AC output source; FIG. 5502 shows the AC input source; and FIG. 5.504 shows the DC input (+5V), where an AC adapter plugs in to provide power to the chassis.

FIG. 6.600 is a wall outlet or optional surge suppressor. FIG. 6.602 shows the adapter supplying +5V to the chassis.

In further detail, FIG. 11 shows a process flow of the chassis. In FIG. 11.110, the wireless chip runs a self-check and loads the program into its memory. FIG. 11.112 polls the computer-based software application for a wireless-connection request or a power-down signal. If no signal is received, per FIG. 11.200, the system waits for a connection request; if a signal is received, per FIG. 11.202, the wireless chip connects to the computer. If the chip receives a wireless signal to power down the computer, per 11.204, it then switches the relay open, per 11.300. If no such signal is received, the wireless pairing is disconnected, per 11.302, and the system idles while awaiting a connection request, per 11.200.

When the computer-based software application receives one or more local bad-weather alerts (e.g., tornado watch or thunderstorm warning) from its cloud-based companion program, the computer-based program starts a 5-minute countdown timer (1.302) to shut down (FIG. 1.502) and virtually unplug (FIG. 11.300) the computer.

The timer appears on the computer's screen or monitor, along with a local bad-weather warning (FIG. 1.304). If the user is present, he or she may manually shut down (FIG. 1.400) the computer or abort the shutdown (FIG. 1.402) before the 5-minute mark. Otherwise, an optional text or email (based on user Preferences) is sent to the user (FIG. 1.306) as the countdown continues.

Just before shutting down the computer with the expiration of the 5-minute timer (FIG. 1.404), one embodiment of the software application attempts to save any data and close any active programs (FIG. 1.406). Then it wirelessly signals (FIG. 1.500) the hardware chassis to virtually unplug the computer (FIG. 11.300). “Virtually” is used herein to emphasize the computer physically remains plugged into a wall outlet or available surge suppressor.

After receiving the power-down signal, the chassis' wireless chip is programmed to wait 20 seconds (FIG. 11.208) before cutting power to the computer. The 20-second delay, which may be adjusted up or down programmatically, is designed to give the computer time to save data, close any open programs and shut down the computer before cutting power.

Optionally, a buzzer (FIG. 9.904) connected to the chassis circuit board sounds moments before the computer shutdown.

The computer is virtually unplugged via an internal circuit relay switch (FIGS. 8.802, 11.206). Power flows to the computer when the relay switch is closed (FIG. 8.804) and, conversely, power is cut when the relay switches open upon a control signal from the chassis' wireless chip.

In more detail, FIG. 8.804 shows an enabling of the EN PASSTHRU control signal that lets power pass between a pair of connectors of the chassis' two AC plugs—one connecting the chassis to a wall outlet or available surge suppressor and the second connecting the chassis to the computer. To cut power and virtually unplug the computer, the flow of voltage is cut from +3V to 0V or ground, collapsing the magnetic field and forcing the relay to switch open.

The relay is designed to automatically reset to its default position of closed, allowing power to pass through, when power is available and the computer turned on again.

### DESCRIPTION—ADDITIONAL EMBODIMENTS—FIGS. 12-15

Additional embodiments are shown in FIGS. 12-15. FIG. 12 shows web-based software (FIG. 12.120), rather than a desktop application, on a Wi-Fi enabled computer, communicating wirelessly (FIG. 9.900) with the chassis (FIG. 4.400).

FIG. 13 is a software application for mobile devices (FIG. 13.130) such as Apple iPhones and Android smartphones, using IOS and Android programming, respectively.

FIG. 14 is a software enterprise application for a computer network.

FIG. 15 shows the chassis now incorporates a conventional surge suppressor (FIG. 15.150) and the software application, housed on the computer in one embodiment.

### OPERATION—ADDITIONAL EMBODIMENTS

In FIG. 12, the web-based software (FIG. 12.120), in this embodiment, operates similar to the first embodiment, but may incorporate aspects such as user log-in to a central membership website. There, users could maintain and change preferences and account settings. A web-based program could be programmed in several languages, such as Java or C++.

In FIG. 13, this additional embodiment of a software application for mobile devices (FIG. 13.130), the user's GPS-enabled smartphone may be used to pre-populate his or her location in the Preferences area of the software application.

In FIG. 14, the software application in this embodiment is installed on a computer network (FIG. 14.140) in lieu of individual computers.

In FIG. 15, the chassis is modified in this embodiment to incorporate a conventional surge suppressor (FIG. 15.150) containing one or more AC female receptacles where power cords for computers and other electronic devices are plugged in. Such devices may include, but are not limited to, printers, cordless, multiple-handset telephones, smart TVs, home entertainment centers, air conditioners, and other appliances and utilities. This provides an additional layer of security to these devices.

The chassis is further modified, in FIG. 15, to also incorporate the software application (FIG. 1.200), housed on the user's computer in one embodiment. In this embodiment, the chassis-housed software obtains weather alerts wirelessly from the cloud-based software component (1.204), or directly from a weather service or online weather station.

### Conclusion, Ramification, and Scope

Thus the reader will see that at least one embodiment of this combination software-hardware system proactively protects unattended Windows and Mac computers and tablets, while plugged into a wall outlet or surge suppressor, against power surges and outages caused by lightning strikes and other bad weather.

Furthermore, the system provides remote, automatic protection to unattended computers.

This system has the potential to save homes and businesses a lot of money otherwise lost each year to countless lightning strikes and related electrical problems. Specifically, the system guards against data loss and hardware damage and destruction.

This system, in other embodiments, offers the same protection to mobile devices, computer networks, and other wireless devices.

While surge suppressors offer reliable protection, this system offers an additional layer of security that becomes especially effective, in one embodiment of this system, when surge protection is incorporated into the hardware chassis.

While the above description contains many specificities, these should not be construed as limitations on the scope, but rather as an exemplification of several embodiments thereof. Other variations are possible. For example, the size, shape and material used for the chassis may vary. A rubberized chassis may make an acceptable embodiment.

The 20-second delay before the chassis shuts down the computer, in one embodiment, can be adjusted up or down.

Instead of obtaining bad-weather alerts from one or more weather-service APIs, in one embodiment, such alerts may be available from internet weather stations.

The relay switch used in the chassis' circuitry to virtually unplug the user's computer or other device, in one embodiment, could be replaced with another method of interrupting the power supply to the computer or other device. A possible alternate method might involve rotating two parts of the chassis or inner circuitry to disconnect the power supply to the computer. This embodiment might require a chassis made of separate parts.

The optional email or text, warning users of an impending computer shutdown, in one embodiment, could be expanded to allow a user to remotely abort the shutdown, or command an immediate shutdown, with a reply email or text recognized by the system.

The chassis could be battery-powered (e.g., one AA battery), eliminating the need for the AC adapter which, in one embodiment, plugs into the DC input of the chassis, providing power to the chassis.

Further, the AC adapter can be eliminated by instead drawing power from the AC input source or cord. This requires additional chassis components and isolation circuitry.

Thus, the scope should be determined not by the embodiments illustrated, but by the appended claims and their legal equivalents.

I claim:

1. A process that automatically turns off a computer, computer network, tablet, mobile device or appliance and, using a hardware chassis, then unplugs the machine, upon receiving a bad-weather alert for the vicinity, comprising the steps of:
a. Checking one or more national or global weather service or online weather station for bad-weather alerts
b. Displaying the alert or alerts on-screen only for the affected user, if present
c. Activating a 5-minute countdown timer, and allowing the user, if present, to manually shut down the computer, or abort the shutdown, before the timer expires
d. Emailing or texting notification of the alert and imminent computer shutdown
e. Aborting the shutdown or doing an immediate shutdown if the user sends a reply email or text
f. Attempting to save data and close any open programs
g. Signaling a hardware chassis wirelessly to unplug the computer or other machine
h. Turning off the computer or other machine as the timer expires
i. Unplugging the computer or other machine virtually
(1) Virtually means a wireless chip in the chassis switches a relay to a position that cuts power to the computer or other machine. The relay is part of a circuit board in the chassis. One conventional AC cord connects a wallet out to the chassis, and a second such cord connects the chassis to the computer or other device. The relay switch virtually unplugs the computer or other machine, because it remains physically plugged into the wall outlet.

2. A similar process using a modified hardware chassis, comprising:
a. Functionality of a conventional surge protector for additional security
b. Programming for process steps a-g in claim 1 above housed in the chassis instead
